(19) United States
(12) Patent Application Publication
(10) Pub. No.: US 2025/0010531 A1
(43) Pub. Date: Jan. 9, 2025

(54) INJECTION MOLDING SYSTEM

(71) Applicant: CANON VIRGINIA, INC., Newport News, VA (US)

(72) Inventors: Tomohiro Shima, Yorktown, VA (US); Mizuho Tashiro, Yorktown, VA (US)

(21) Appl. No.: 18/712,196

(22) PCT Filed: Nov. 15, 2022
(86) PCT No.: PCT/US2022/079900

§ 371 Date: May 21, 2024

Related U.S. Application Data
(60) Provisional application No. 63/282,092, filed on Nov. 22, 2021.

(51) Int. Cl. B29C 45/64; B29C 45/04

(52) U.S. Cl. CPC B29C 45/64; B29C 45/0416; B29C 2045/645

(57) ABSTRACT

An injection molding system includes an injection unit that injects resin into a mold and a coupling member that couples a fixed mold plate and a movable mold plate of the mold, wherein an improvement to the injection molding system includes a driving member that separates the fixed mold plate from a fixed platen by moving the movable mold plate when the fixed mold plate and the movable mold plate are coupled by the coupling member.

### CROSS-REFERENCE TO RELATED APPLICATION

This application claims the benefit of the U.S. Provisional Application 63/282,092, which was filed on Nov. 22, 2021.

### FIELD

The disclosure herein relates to an injection molding system for manufacturing plastic parts.

### BACKGROUND

Manufacturing of molded parts by an injection molding machine includes clamping a mold, injecting a resin into a mold, pressing the resin into the mold at a high pressure in order to compensate for a volume decrease due to solidification of the resin, keeping the molded part in the mold until the resin solidifies, and removing the molded part from the mold. The injection molding process is repeatedly performed to obtain a desired number of molded parts. After a predetermined number of moldings are performed with one mold, the mold is ejected from the injection molding machine, the next mold is setup and inserted into the injection molding machine. A predetermined number of injection moldings with the next mold is then performed.

The above process can take time and resources, and typically the injection molding machine remains in a waiting condition during the process. This can affect overall productivity. Since the mold is heavy and becomes heated during use, it is necessary to consider the safety of the operator.

In the above-described molding approach, a method using two molds with one injection molding machine has been proposed. For example, US 2018/0009146/Japanese patent publication No. 2018-001738/VN20160002505 are seen to discuss a system in which conveying machines are arranged on both sides of an injection molding machine. In this system, molded parts are manufactured while alternating a plurality of molds by conveying devices for the one injection molding machine.

The injection molding system of US 2018/0009146/Japanese patent publication No. 2018-001738/VN20160002505, includes spring rollers that are embedded in inner surfaces of a fixed platen and a movable platen of the injection molding machine. The spring rollers enable separating the fixed platen surface from a mold mounting surface when a mold is conveyed out of the injection molding machine and a guiding function when the mold is conveyed in/out of the injection molding machine. To achieve this, grooves for embedding the spring rollers in the platens of the injection molding machine and to arrange a plurality of spring rollers were created, which impacts cost for the injection molding system.

What is needed is an injection molding system that enables separating of platens in a more efficient manner.

### SUMMARY

An exemplary aspect of the present disclosure includes an injection molding system comprising an injection unit for injecting resin into a mold, a coupling member for coupling a fixed mold plate and a movable mold plate of the mold, and a driving member for separating the fixed mold plate from the fixed platen by moving the movable mold plate in a state where the fixed mold plate and the movable mold plate are coupled by the coupling member.

### BRIEF DESCRIPTION OF THE DRAWINGS

The accompanying drawings, which are incorporated herein and form part of the Specification, illustrate various embodiments, objects, features, and advantages of the present disclosure.

FIG. 1 illustrates a view of an injection molding system of an exemplary embodiment viewed from a Z-axis direction.

FIG. 2 illustrates a view of an exemplary injection molding system viewed from an X-axis direction.

FIG. 3 illustrates a view of a fixed platen of an exemplary embodiment viewed from a Y-axis direction.

FIGS. 4A-4I illustrates a mold opening/closing operation flow of the exemplary embodiment.

FIG. 5 illustrates a flow chart of the operation of the injection molding system of the exemplary embodiment.

FIGS. 6A-6B illustrates a view of an injection molding system of an exemplary embodiment viewed from an X-axis direction.

FIG. 7 illustrates a view of an injection molding system of an exemplary embodiment viewed from an X-axis direction.

FIGS. 8A-8B illustrates a view of an injection molding system of an exemplary embodiment viewed from an X-axis direction.

FIG. 9 illustrates a spring portion of ball plunger according to an exemplary embodiment.

Throughout the Figures, the same reference numerals and characters, unless otherwise stated, are used to denote like features, elements, components or portions of the illustrated embodiments. While the subject disclosure is described in detail with reference to the Figures, it is done so in connection with the illustrative exemplary embodiments. It is intended that changes and modifications can be made to the described exemplary embodiments without departing from the true scope and spirit of the subject disclosure as defined by the appended claims.

### DESCRIPTION OF THE EMBODIMENTS

The present disclosure has several embodiments and relies on patents, patent applications and other references for details known to those of the art. Therefore, when a patent, patent application, or other reference is cited or repeated herein, it should be understood that it is incorporated by reference in its entirety for all purposes as well as for the proposition that is recited.

With reference to the drawings, an injection molding system according to an embodiment of the present disclosure will be described. The arrow symbols X and Y in each Figure indicate horizontal directions that are orthogonal to each other, and the arrow symbol Z indicates a vertical (perpendicular) direction.

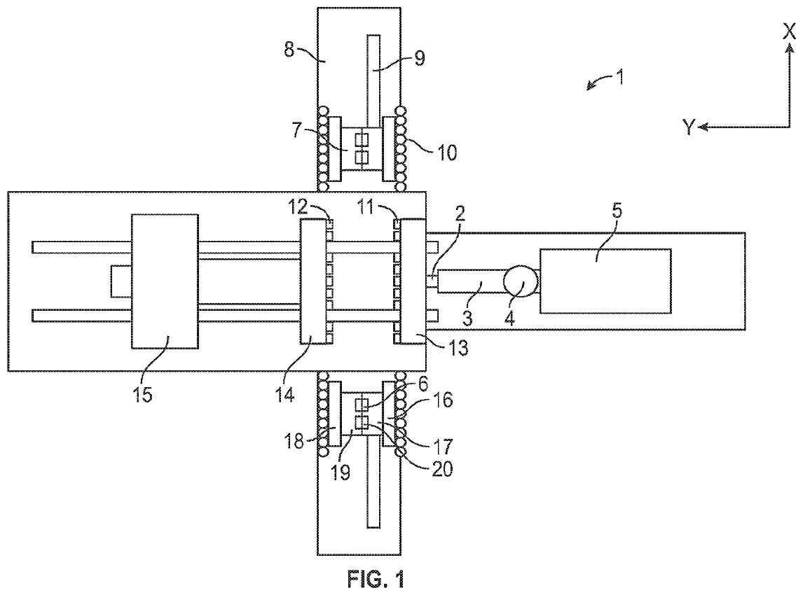

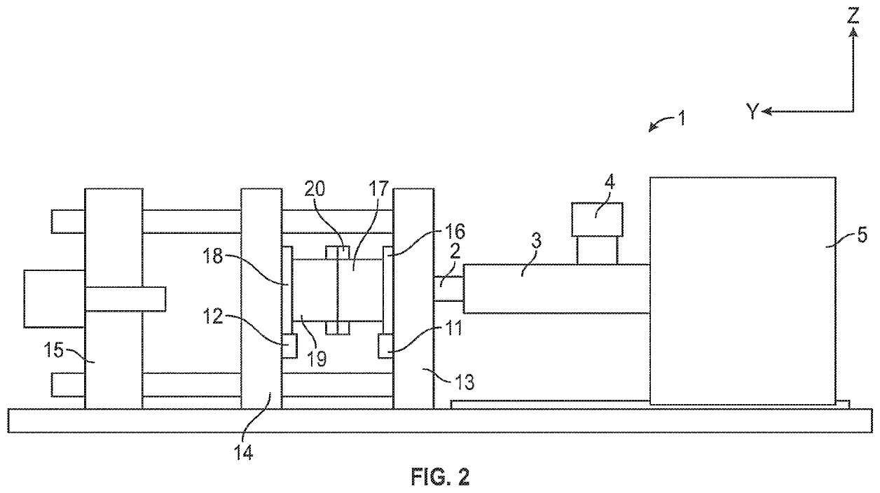

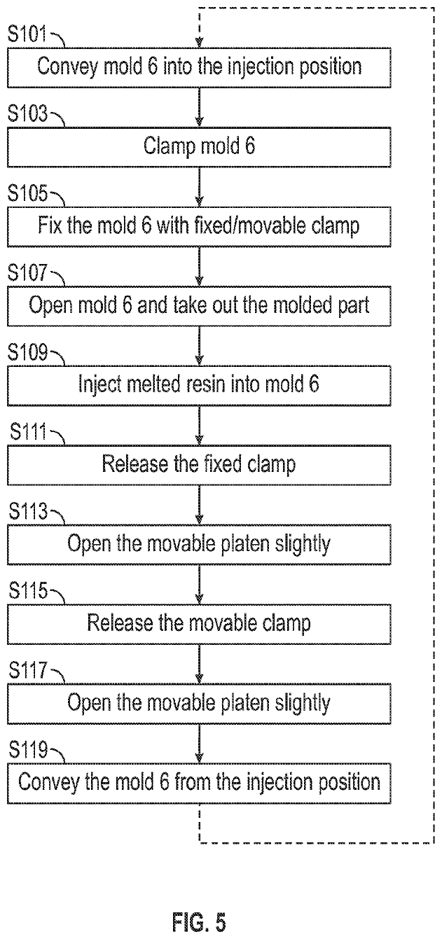

FIG. 1 illustrates a view of an injection molding system 1 of an exemplary embodiment viewed from a Z-axis direction. FIG. 2 illustrates a view of the injection molding system 1 viewed from an X-axis direction. FIG. 5 illustrates a flow chart describing the operation of the injection molding system 1. Each of the steps illustrated in FIG. 5 is realized by a processor (not illustrated) of the injection molding system 1 reading and executing a program stored in a memory (not illustrated).

The injection molding system 1 comprises a horizontal injection unit 5 including an injection nozzle 2, an injection cylinder 3, and a hopper 4. The injection unit injects a resin into a mold. A mold conveying device 8, that alternately conveys a mold 6 and a mold 7 into and out of an injection position, is installed on both sides of the injection position in the X-axis direction. The injection position is a position suitable for injection processing by the injection unit 5. The mold conveying device 8 is equipped with a driving source (not illustrated), a linking member 9, and a guide roller 10 for guiding conveyance of the mold 6 and the mold 7. While FIG. 1 illustrates these elements in the top portion of FIG. 1, the bottom portion is a mirror image and the same reference numbers are applicable.

The injection molding system 1 also comprises a fixed bottom surface roller 11 and a movable bottom surface roller 12 for supporting a mold via the bottom surface when the mold is conveyed to the injection position. A fixed platen 13, a movable platen 14, and a mold clamping force generating device 15 are also part of the injection molding system 1. Mold 6 and mold 7 both comprise a fixed clamping plate 16, a fixed mold plate 17, a movable clamping plate 18, a movable mold plate 19, and a magnetic lock 20 that is provided at the boundary between the fixed mold plate 17 and the movable mold plate 19. While FIG. 1 illustrates these elements with respect to mold 6, they are applicable to mold 7 as well.

FIG. 3 illustrates a view of the fixed platen of the present embodiment viewed from a Y-axis direction. The fixed bottom surface roller 11 is arranged between a fixed mold clamp 21 and a tie bar 22 to perform a guide function when conveying a mold. A location ring hole 23 is opened on the fixed side. (Please note that reference number 23 is used below for other elements. Please update the reference number for those elements such that reference number 23 is not reused. Please ensure that any changes made to the Specification are also reflected in the appropriate corresponding Figure(s))

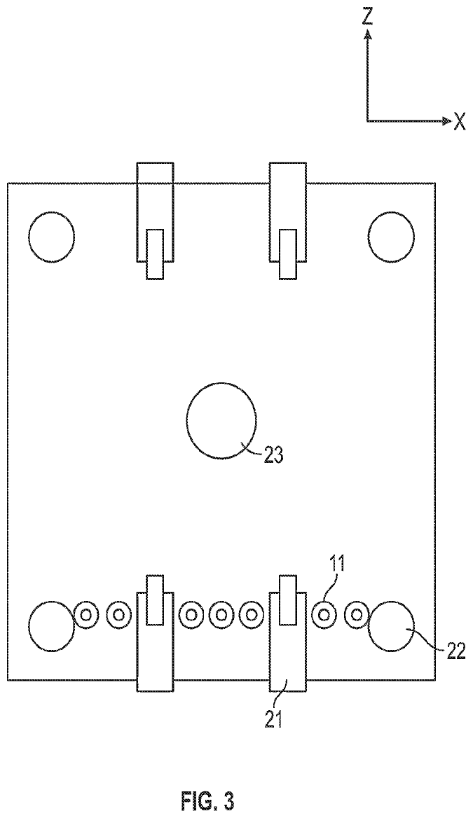

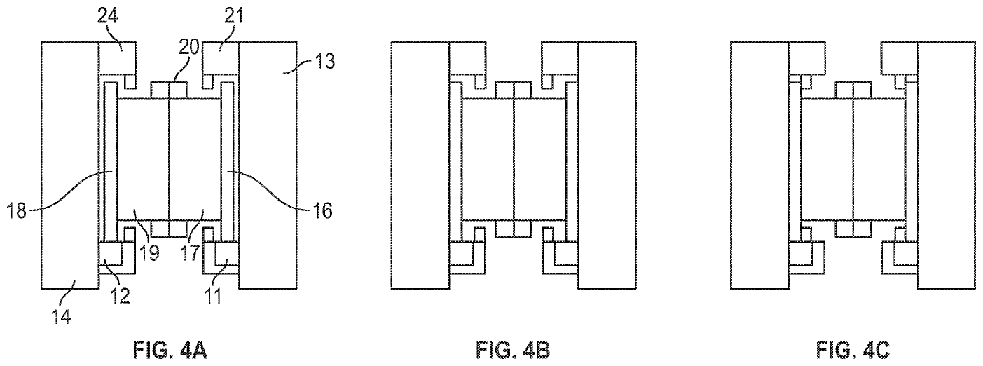

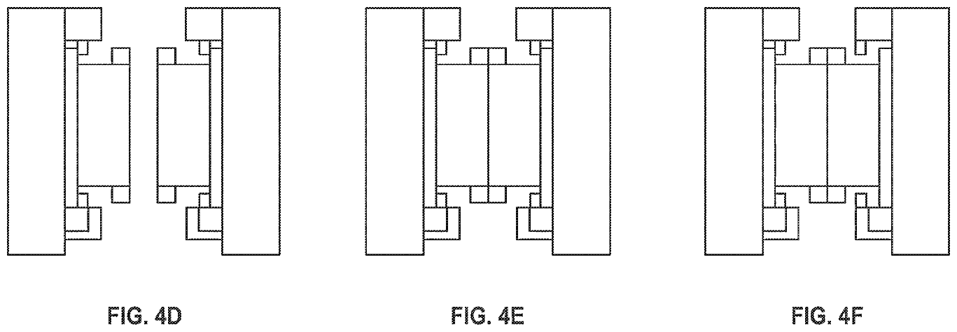

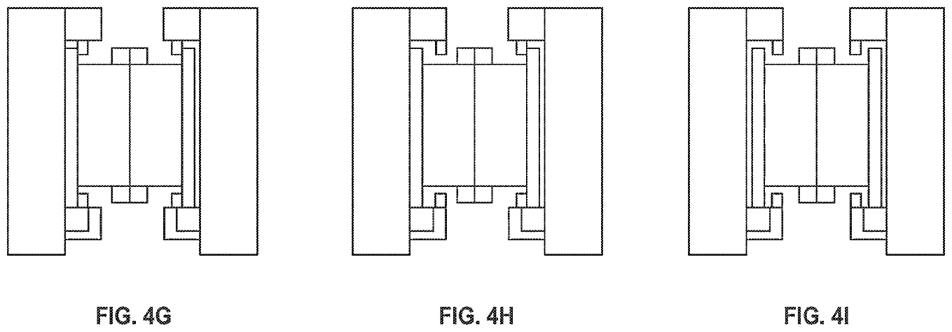

FIGS. 4A-4I illustrate a mold opening/closing operation flow of the present embodiment. More specifically, FIGS. 4A-4I illustrate states from when a mold is conveyed into the injection position to when a molded part is removed, injection filled, and the mold conveyed out of the injection position.

FIG. 4A illustrates a state when a mold is conveyed into the injection position. FIG. 4B illustrates a closed state of the mold where the movable platen 14 is closed. FIG. 4C illustrates a state where the fixed mold clamp 21 and the movable mold clamp 24 are simultaneously clamped. FIG. 4D illustrates a state where the movable platen 14 is opened and the molded part removed. FIG. 4E illustrates a state where the movable platen 14 is closed and resin injected and filled. FIG. 4F illustrates a state where just the fixed mold clamp 21 is released after the injection filling. FIG. 4G illustrates a state where the movable platen 14 is slightly opened and the fixed clamping plate 16 and the fixed platen 13 of the mold are separated. FIG. 4H illustrates a state where the movable mold clamp 24 is released. FIG. 4I illustrates a state where the movable platen 14 is again slightly opened and the movable platen 14 and the movable clamping plate 18 of the mold are separated.

FIG. 5 illustrates a flow chart of the operation of the injection molding system 1 of the present embodiment.

In step S101, the mold 6 is conveyed in the X-axis direction by the driving source (not illustrated) of the mold conveying device 8 and the linking member 9 of the mold 6 into the space between the fixed platen 13 and the movable platen 14 of the injection molding system 1. FIG. 4A illustrates a view of the state when the mold 6 is conveyed into the injection position viewed from the X-axis direction.

In step S103, the mold 6 is clamped. Then, in step S105, the fixed mold clamp 21 and the movable mold clamp 24 are operated to fix the mold 6 to the fixed platen 13 and the movable platen 14. FIG. 4C illustrates this the state.

When a cooling time of the resin that was previously injected into the mold 6 has elapsed, in step S107, the movable platen 14 is opened to remove a molded part from the mold 6. FIG. 4D illustrates the state where the mold 6 is opened and a molded part is removed. In a case where a first molding operation is being performed, this process can be omitted because there is no molded part yet.

In step S109, melted resin in the injection cylinder 3 is injected into the mold 6 via the injection nozzle 2. FIG. 4E illustrates this state.

In step S111, after the injection and dwelling processes are completed, the fixed mold clamp 21 is released in order to convey the mold A from the injection position. FIG. 4F illustrates the state when the fixed mold clamp 21 is released. At this time, the movable mold clamp 24 maintains a clamping force on the mold 6.

The movable platen 14 is then slightly opened in step S113. By slightly opening the movable platen 14 while clamping the movable clamping plate 18 of the mold A, the fixed platen 13 and the fixed clamping plate 16 are separated. That is, a force for movement with respect to the movable platen 14 is provided in a state where coupling between the fixed clamping plate 16 and the movable platen 14 is maintained by the movable mold clamp 24. FIG. 4G illustrates the state after the movable platen 14 is moved.

The magnet lock 20 provides an adhesion force stronger than a frictional force generated between the mold 6 and the fixed bottom surface roller 11, which enables the mold 6 to be integrally moved without separating the fixed mold plate 17 and the movable mold plate 19. That is, the magnet lock 20 functions as a coupling member for coupling the fixed mold plate 17 and the movable mold plate 19 of the mold 6 with a magnetic force. The fixed clamping plate 16 can be separated from the fixed platen 13 by moving the movable mold plate 19 with the fixed mold plate 17 and the movable mold plate 19 coupled by the magnet lock 20. The magnet lock 20 can be fixed to any side surface of the fixed mold plate 17 and the movable mold plate 19. In another exemplary embodiment, another fixing member such as a hydraulic jack can be provided instead of the magnet lock 20.

As illustrated in FIGS. 4A-4I, the moving direction of the movable mold plate 19 in step S113 is parallel to an injection direction of the resin by the injection unit 5. The moving direction of the movable mold plate 19 in step S113 is the reverse of the moving direction of the movable mold plate 19 in the mold clamping process in S103.

In step S115, the movable mold clamp 24 is released. FIG. 4H illustrates this state.

In step S117, the movable platen 14 is again slightly opened, and the movable platen 14 and the movable clamping plate 18 are separated. To more reliably separate the movable platen 14 and the movable clamping plate 18, in the present embodiment, the fixed clamping plate 16 hooks on an edge or flange portion of the fixed mold clamp 21 or the fixed bottom surface roller 11. When a gap is generated between the movable platen 14 and the movable clamping plate 18, this enables preventing the movable platen 14 and the movable clamping plate 18 from rubbing and wearing down when a mold is conveyed out of the injection position. FIG. 4I illustrates this state.

In step S119, The mold 6 is conveyed from the injection position, where the mold 6, the fixed platen 13, and the movable platen 14 are not in contact with each other.

After the mold 6 is conveyed from the injection position, steps S101-S119 of FIG. 5 are then performed for the mold 7.

Steps S101-S119 are repeated in the order of mold 6, moldB7, mold 6, mold 7, etc. until a target production number of molded parts for each of the molds is reached.

The above-described embodiments makes is possible to separate a mold and a platen when conveying the mold from an injection position without requiring the platen to include spring rollers.

The guide function of the above-described embodiment helps to increase a conveying speed of a mold, as well as help realize a safer conveying process for a mold. This can be achieved via a flange portion on a bottom roller, and by positively abutting the mold on the flange portion of the bottom roller at the time of conveyance.

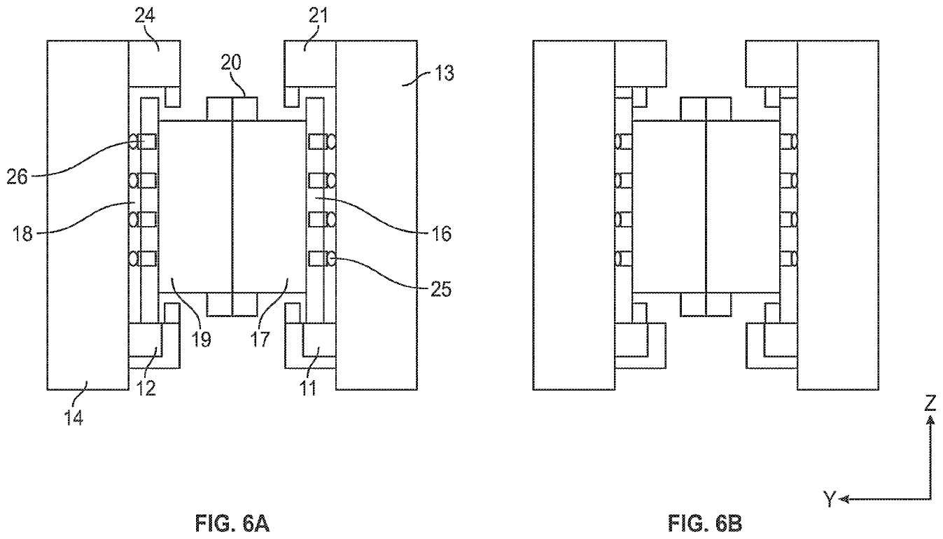

FIGS. 6A-6B illustrate a view of the injection molding system 1 of another exemplary embodiment 2 viewed from an X-axis direction, with a focus on a platen portion and a mold portion of the injection molding system 1. FIG. 6A illustrates a state when a mold is conveyed into or from a space between the fixed platen 13 and the movable platen 14. FIG. 6B illustrates a state when a mold is closed by the mold closing operation of the movable platen 14.

As illustrated in FIG. 6A, a fixed ball plunger 25 and a movable ball plunger 26 are embedded in the fixed clamping plate 16 and the movable clamping plate 18 of a mold, respectively. The mold is conveyed in and out of the injection position while the ball portions (not illustrated) of the fixed ball plunger 25 and the movable ball plunger 26 slide, respectively, with the fixed platen 13 or the movable platen 14.

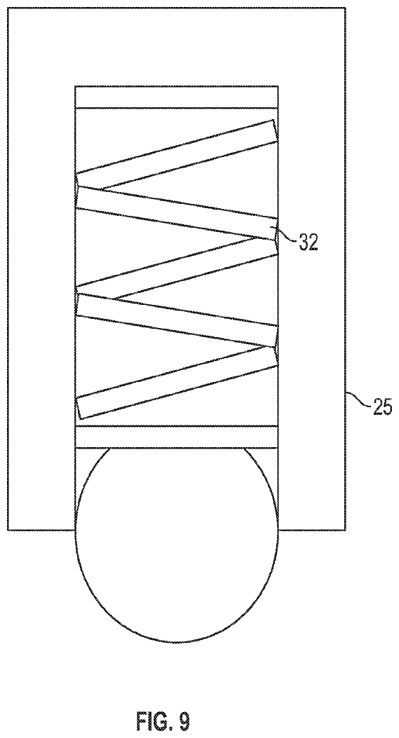

After the mold is conveyed into the injection position, a spring portion 32, as illustrated in FIG. 9, of the fixed ball plunger 25 and the movable ball plunger 26 contract by being compressed along with the mold closing operation of the movable platen 14, and the fixed ball plunger 25 and the movable ball plunger 26 retract into the mold clamping plate 16, so that the injection filling operation is not hindered.

As described in FIG. 5, clamps on the fixed side and the movable side are not separately released. More specifically, after step S109, the fixed mold clamp 21 and the movable mold clamp 24 are simultaneously released. The movable platen 14 is opened, and the mold is pushed up by the force of the spring portion 32 of the of the fixed ball plunger 25 and the movable ball plunger 26 to separate the mold clamping plate 16 from the fixed platen 13 and the movable platen 14.

While the magnet lock 20 functioned as a coupling member for coupling the fixed mold plate 17 and the movable mold plate 19 in the previous embodiment, in the present embodiment, the fixed mold plate 17 and the movable mold plate 19 are coupled by an elastic force provided by the spring portion 32 of the fixed ball plunger 25 and the movable ball plunger 26. More specifically, the fixed mold plate 17 and the movable mold plate 19 are coupled using the elastic force of the spring portion 32 of the fixed ball plunger 25 provided between the fixed mold plate 17 and the fixed platen 13 and the elastic force of the spring portion 32 of the movable ball plunger 26 provided between the movable mold plate 19 and the movable platen 14.

When, for example, a spring roller is embedded in a platen, it is necessary to assume a maximum mold weight to be used in the injection molding system when selecting the part. However, when embedding a ball plunger in a mold, it is sufficient to select a part suitable for the mold's weight, so that a design with a reduced cost becomes possible without generating an excessive mold push-up force. By utilizing the thickness of a clamping plate of a mold, it is possible to provide a sliding function to the mold clamping without losing the thickness of the mold.

In an exemplary embodiment, to address an issue of wear caused by sliding of a ball portion of a ball plunger and a platen, a thin plate with a degree of hardness greater than the platen can be inserted between the platen and a mold clamping plate so the mold clamping plate can be replaced based on amount of wear.

In another exemplary embodiment, to avoid loss of mold thickness, a space can be formed where a thin plate can be embedded in a platen and the thin plate can be fixed therein.

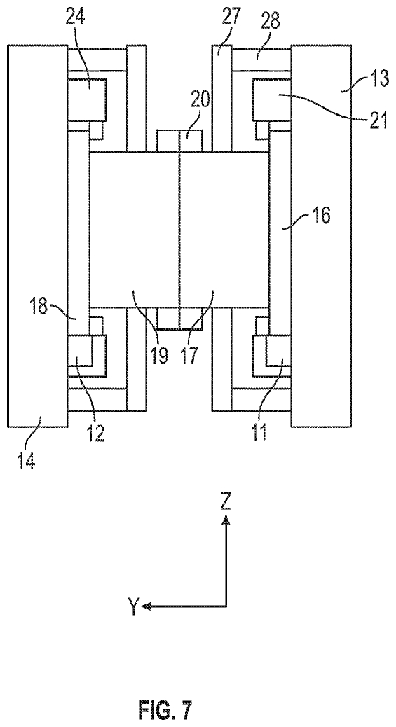

FIG. 7 illustrates a view of the injection molding system 1 of another exemplary embodiment viewed from an X-axis direction with a focus on a portion between the fixed platen 13 and the movable platen 14 of the injection molding system 1. More specifically, FIG. 7 illustrates a state where a mold is fixed by the fixed mold clamp 21 and the movable mold clamp 24 in a space between the fixed platen 13 and the movable platen 14. As illustrated in FIG. 7, a mold is provided with a cylinder fixing part 27 and a cylinder 28. After the fixed mold clamp 21 and the movable mold clamp 24 are released and the movable platen 14 is opened, the fixed platen 12 and the movable platen 14 are pushed by driving the cylinder 28 to separate the fixed platen 13 and the movable platen 14 from the fixed clamping plate 16 and movable clamping plate 18. Thus, it is possible to avoid wear due to sliding of a mold and the fixed platen and the movable platen when conveying the mold.

The driving mechanism (not illustrated) of the cylinder 28 can be any type of driving source, such as hydraulic pressure, air, etc.

In another exemplary embodiment, to avoid the cylinder 28 from directly pushing on the fixed platen and the movable platen, a thin receiving plate (not illustrated) can be provided between the cylinder 28 and the fixed platen 13 and the movable platen 14.

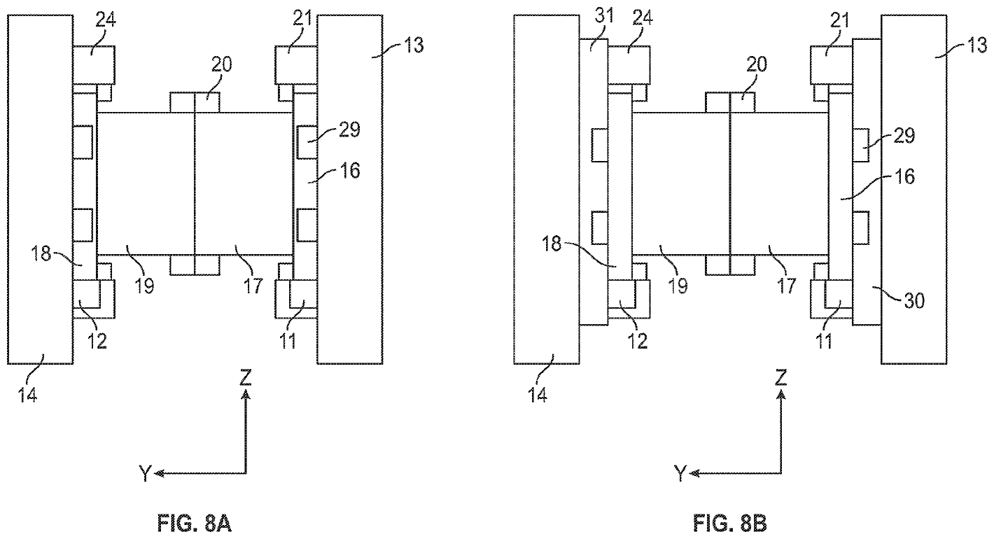

FIGS. 8A and 8B illustrate a view of the injection molding system 1 of another exemplary embodiment viewed from an X-axis direction with a focus on a platen portion and a mold portion. FIG. 8A illustrates a cylinder 29 embedded in the fixed clamping plate 16 and the movable clamping plate 18 respectively. FIG. 8B illustrates a plate 30 located between the fixed clamping plate 16 and the fixed platen 13, where the cylinder 29 can be embedded therein.

In FIG. 8A, since the cylinder 29 is embedded in the fixed clamping plate 16 and the movable clamping plate 18, the thickness of the mold is not affected. Since the cylinder 29 can be embedded in the fixed clamping plate 16 and the movable clamping plate 18, and not in the fixed platen 13 and the movable platen 14 of the injection molding system 1, the cylinder 29 can be selected based on, for example, a weight of the mold.

Based on the configuration illustrated in FIG. 8A, after the fixed mold clamp 21 and the movable mold clamp 24 is released and the movable platen 14 is opened, the fixed platen 13 and the movable platen 14 are pushed by driving the cylinder 29, resulting in the fixed platen 13 and the movable platen 14 separating from the fixed mold clamping plate 16 and the movable mold clamping plate 18. That is, the cylinder 29 embedded in the fixed clamping plate 16 separates the fixed clamping plate 16 and the fixed platen 13 by pushing the fixed platen 13. The cylinder 29 embedded in the movable clamping plate 18 separates the movable clamping plate 18 and the movable platen 14 by pushing the movable platen 14. Thus, it is possible to avoid wear due to sliding of a mold and the fixed platen 13 and the movable platen 14 when conveying the mold.

The driving mechanism (not illustrated) of the cylinder 28 can be any type of driving source, such as hydraulic pressure, air, etc.

In FIG. 8B, while the cylinder 29 is embedded in the fixed mount plate 30 between the fixed clamping plate 16 and the fixed platen 13, the cylinder 29 can be embedded in the movable mount plate 31 between the movable clamping plate 18 and the movable platen 14.

Based on the configuration illustrated in FIG. 8B, after the fixed mold clamp 21 and the movable mold clamp 24 are released and the movable platen 14 is opened, the cylinder 29 embedded in the fixed mount plate 30 between the fixed clamping plate 16 and the fixed platen 13 separates the fixed clamping plate 16 and the fixed mount plate 30 by pushing the fixed clamping plate 16, and the cylinder 29 embedded in the movable mount plate 31 between the movable clamping plate 18 and the movable platen 14 separates the movable clamping plate 18 and the movable mount plate 31 by pushing the movable clamping plate 18. Thus, it is possible to avoid wear due to sliding of the mold and the fixed mount plate 30 and the movable mount plate 31 when conveying the mold.

### Definitions

In referring to the description, specific details are set forth in order to provide a thorough understanding of the examples disclosed. In other instances, well-known methods, procedures, components and circuits have not been described in detail as not to unnecessarily lengthen the present disclosure.

It should be understood that if an element or part is referred herein as being “on”, “against”, “connected to”, or “coupled to” another element or part, then it can be directly on, against, connected or coupled to the other element or part, or intervening elements or parts may be present. In contrast, if an element is referred to as being “directly on”, “directly connected to”, or “directly coupled to” another element or part, then there are no intervening elements or parts present. When used, term “and/or”, includes any and all combinations of one or more of the associated listed items, if so provided.

Spatially relative terms, such as “under” “beneath”, “below”, “lower”, “above”, “upper”, “proximal”, “distal”, and the like, may be used herein for ease of description to describe one element or feature's relationship to another element(s) or feature(s) as illustrated in the various figures. It should be understood, however, that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, a relative spatial term such as “below” can encompass both an orientation of above and below. The device may be otherwise oriented (rotated 90 degrees or at other orientations) and the spatially relative descriptors used herein are to be interpreted accordingly. Similarly, the relative spatial terms “proximal” and “distal” may also be interchangeable, where applicable.

The term “about,” as used herein means, for example, within 10%, within 5%, or less. In some embodiments, the term “about” may mean within measurement error.

The terms first, second, third, etc. may be used herein to describe various elements, components, regions, parts and/or sections. It should be understood that these elements, components, regions, parts and/or sections should not be limited by these terms. These terms have been used only to distinguish one element, component, region, part, or section from another region, part, or section. Thus, a first element, component, region, part, or section discussed below could be termed a second element, component, region, part, or section without departing from the teachings herein.

The terminology used herein is for the purpose of describing particular embodiments only and is not intended to be limiting. The use of the terms “a” and “an” and “the” and similar referents in the context of describing the disclosure (especially in the context of the following claims) are to be construed to cover both the singular and the plural, unless otherwise indicated herein or clearly contradicted by context. The terms “comprising,” “having,” “includes”, “including,” and “containing” are to be construed as open-ended terms (i.e., meaning “including, but not limited to,”) unless otherwise noted. Specifically, these terms, when used in the present specification, specify the presence of stated features, integers, steps, operations, elements, and/or components, but do not preclude the presence or addition of one or more other features, integers, steps, operations, elements, components, and/or groups thereof not explicitly stated. Recitation of ranges of values herein are merely intended to serve as a shorthand method of referring individually to each separate value falling within the range, unless otherwise indicated herein, and each separate value is incorporated into the specification as if it were individually recited herein. For example, if the range 10-15 is disclosed, then 11, 12, 13, and 14 are also disclosed. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

It will be appreciated that the methods and compositions of the instant disclosure can be incorporated in the form of a variety of embodiments, only a few of which are disclosed herein. Variations of those embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. An injection molding system comprising:
a coupling member configured to couple a fixed mold plate of a mold and a movable mold plate of the mold;
a fixed mold clamp configured to maintain coupling of a fixed clamping plate and a fixed platen, the fixed clamping plate being connected with the fixed mold plate;
a movable mold clamp configured to maintain coupling a movable clamping plate and a movable platen, the movable clamping plate being connected with the movable mold plate; and
a driving member configured to separate the fixed clamping plate from the fixed platen by moving the movable platen after the fixed mold clamp releases the coupling between the fixed clamping plate and the fixed platen in a state where: (1) the fixed mold plate and the movable mold plate are coupled by the coupling member, and (2) the movable mold clamp maintains the coupling between the movable clamping plate and the movable platen.

2. The injection molding system according to claim 1, wherein the coupling member includes a magnet configured to couple the fixed mold plate and the movable mold plate with a magnetic force.

3. The injection molding system according to claim 1, wherein the coupling member includes a spring configured to couple the fixed mold plate and the movable mold plate with an elastic force.

4. The injection molding system according to claim 3, wherein the spring is located between the fixed clamping plate and the fixed platen.

5. The injection molding system according to claim 1, wherein the coupling member includes a ball plunger arranged on the movable clamping plate and the fixed clamping plate of the mold, respectively.

6. The injection molding system according to claim 5, further comprising a plate with a hardness value greater than a hardness value of the fixed platen, wherein the plate is provided between the movable clamping plate and a movable platen or between the fixed clamping plate and the fixed platen.

7. The injection molding system according to claim 1, wherein the driving member is configured to move the movable platen in an injecting direction as resin is injected by an injection unit.

8. The injection molding system according to claim 7, further comprising a conveying member configured to convey the mold in a conveyance direction that differs from the injecting direction, wherein the driving member is configured to move the movable platen after resin is injected into the mold and before the mold is conveyed by the conveying member.

9. The injection molding system according to claim 1, wherein the driving member is configured to move the movable platen in a mold clamping process, and wherein a moving direction of the movable platen for separating the fixed clamping plate from the fixed platen is opposite a moving direction of the movable platen in the mold clamping process.

10. (canceled)

11. The injection molding system according to claim 1, wherein the movable mold clamp is configured to release the coupling after moving the movable platen and then the driving member is configured to separate the movable clamping plate from the movable platen by moving the movable platen.

12. (canceled)

13. An injection molding machine comprising:
an injection unit configured to inject resin into a mold;
a coupling member configured to couple a fixed mold plate of the mold and a movable mold plate of the mold;
a fixed mold clamp configured to maintain coupling of a fixed clamping plate and a fixed platen, the fixed clamping plate being connected with the fixed mold plate;
a movable mold clamp configured to maintain coupling of a movable clamping plate and a movable platen, the movable clamping plate being connected with the movable mold plate, and
a driving member configured to separate the fixed clamping plate from the fixed platen by moving the movable platen after the fixed mold clamp releases the coupling between the fixed clamping plate and the fixed platen in a state where: (1) the fixed mold plate and the movable mold plate are coupled by the coupling member, and (2) the movable mold clamp maintains the coupling between the movable clamping plate and the movable platen.

14. The injection molding machine according to claim 13, wherein the coupling member includes a magnet configured to couple the fixed mold plate and the movable mold plate with a magnetic force.

15. The injection molding system according to claim 13, wherein the coupling member includes a spring configured to couple the fixed mold plate and the movable mold plate with an elastic force.

16. The injection molding machine according to claim 15, wherein the spring is located between the fixed clamping plate and the fixed platen.

17. The injection molding machine according to claim 13, wherein the coupling member includes a ball plunger arranged on the movable clamping plate and the fixed clamping plate of the mold, respectively.

18. The injection molding machine according to claim 17, further comprising a plate with a hardness value greater than a hardness value of the fixed platen, wherein the plate is provided between the movable clamping plate and a movable platen, or between the fixed clamping plate and the fixed platen.

19. The injection molding machine according to claim 13, wherein the driving member is configured to move the movable platen in an injecting direction as the resin is injected by the injection unit.

20. The injection molding machine according to claim 19, operating with a conveying member configured to convey the mold in a conveyance direction that differs from the injecting direction, wherein the driving member is configured to move the movable platen after resin is injected into the mold and before the mold is conveyed by the conveying member.

21. The injection molding machine according to claim 13, wherein the driving member is configured to move the movable platen in a mold clamping process, and wherein a moving direction of the movable platen for separating the fixed clamping plate from the fixed platen is opposite a moving direction of the movable platen in the mold clamping process.

22. The injection molding machine according to claim 13, wherein the movable mold clamp is configured to release the coupling after moving the movable platen and then the driving member is configured to separate the movable clamping plate from the movable platen by moving the movable platen.
